(19) United States
(12) Patent Application Publication
(10) Pub. No.: US 2023/0040159 A1
(43) Pub. Date: Feb. 9, 2023

(54) Nutritional Additive for a Coffee Drink

(71) Applicant: Digital Health Solutions Inc, Saint Michael (BB)

(72) Inventors: John Barban, Coronado, CA (US); Kyle Leon, Puslinch (CA)

(21) Appl. No.: 17/444,432

(22) Filed: Aug. 4, 2021

(51) Int. Cl. A23F 5/14; A23L 33/105; A23L 33/155; A23L 33/175; A23L 33/125; A23F 5/02

(52) U.S. Cl. CPC A23F 5/14; A23L 33/105; A23L 33/155; A23L 33/175; A23L 33/125; A23F 5/02

(57) ABSTRACT

A nutritional additive includes a species of Camellia sinensis or an extract derived from the species of Camellia sinensis, an extract of a green coffee bean, and L-theanine or any salt or derivative thereof. A method for preparing the additive is disclosed herein, as well as a coffee drink containing the additive, and a method for preparing the coffee drink.

### FIELD OF THE DISCLOSURE

The present disclosure relates to nutritional additives, and more particularly, to a nutritional additive for a coffee drink.

### BACKGROUND

Coffee is prepared from the roasted ground beans of the Coffea plants, species of which include Coffea arabica, probably the most widely consumed type of coffee. Caffeine is present in the coffee beans of Coffea plants; thus, a drink derived from coffee beans can have a stimulating effect that is associated with the ingestion of caffeine.

However, consumption of a coffee drink can cause negative effects in some people such as jitters, anxiety, nervousness, elevated heart rate, and elevated blood pressure. Ingestion of coffee can also cause a spike in blood sugar and consequently a spike in the production of insulin in the body. Moreover, the stimulation created by consumption of a coffee drink can be followed by an energy crash, which leaves the consumer feeling tired.

The negative effects of consuming a coffee drink can be reduced by abstinence from these types of drinks, exercise, strict diet, or a combination of abstinence, exercise, and dietary discipline. Some people reduce the effect of caffeine in coffee drinks by consuming decaffeinated coffee drinks.

There is an ongoing need to provide other solutions for reducing the negative effects of coffee drink consumption.

### SUMMARY

Disclosed herein is a nutritional additive (e.g., a coffee additive) that includes a species of Camellia sinensis or an extract derived from the species of Camellia sinensis, an extract of a green coffee bean, and L-theanine or any salt or derivative thereof.

Disclosed herein is a method for preparing the additive disclosed herein, which can include mixing a first set of ingredients comprising a species of Camellia sinensis or an extract derived from the species of Camellia sinensis, an extract of a green coffee bean, and L-theanine or any salt or derivative thereof, in any of the amounts disclosed herein.

Disclosed herein is a coffee drink that contains the disclosed additive.

Disclosed herein is a method for preparing a coffee drink that can include mixing a coffee-containing liquid or coffee-derived drink (e.g., coffee, cappuccino, latte, expresso) with an embodiment of the additive disclosed herein.

### DETAILED DESCRIPTION

The term “coffee bean” as used herein refers to the seeds that are obtained by removing the pulp and the skin from coffee berries (or cherries) of Coffea plants. Coffee berries, which contain the coffee bean, are produced by several species of small evergreen plants of the genus Coffea. Coffee beans can be roasted to produce roasted coffee beans that are commonly used to make coffee.

The term “green coffee bean” as used herein refers to a coffee bean that is not roasted.

The term “coffee” as used herein refers to the liquid product made by passing water over coffee beans. The coffee can be made by any method, such as a drip coffee method or an instant coffee method. A processed derivative of coffee, such as a cappuccino, a latte, or an espresso, can be made by processing the liquid product.

“Coffee drink” as used herein refers to a beverage that contains coffee or the processed derivative of coffee. The coffee drink can be embodied as a hot beverage, a cold beverage, a room-temperature beverage. The coffee drink can be prepackaged in a bottle or in a can.

Disclosed herein is a nutritional additive for a coffee drink, a method for preparing the nutritional additive, a coffee drink containing the nutritional additive, and a method for preparing the coffee drink containing the nutritional additive.

The nutritional additive can include a species of Camellia sinensis or an extract derived from the species of Camellia sinensis, an extract of a green coffee bean, and L-theanine or any salt or derivative thereof. In some embodiments, the nutritional additive can additionally include one or more of L-carnitine or any salt or derivative thereof, Vitamin B12, Vitamin B6, Vitamin D, and chromium picolinate. In additional embodiments, the nutritional additive can further include a carrier.

The nutritional additive easily dissolves in coffee or a coffee drink, without changing the color, taste, and mouthfeel of the coffee or coffee drink. Without being limited by theory, it is believed that the species of Camellia sinensis or an extract derived from the species of Camellia sinensis in combination with an extract of a green coffee bean, when consumed in combination with a coffee drink work synergistically with the coffee or processed derivative of coffee to enhance the metabolic effects of coffee and to enhance the effects of the ingredients to liberate fat from fat cells, increase thermogenesis (the heat the body produces and thus burn more total calories), increase hormones associated with the release of fat, and burn fat as a preference fuel over carbohydrates. The ingredients of the additive also facilitate the transport of fat from fat cells into muscle and liver cells to be burned as fuel. Additional of L-theanine to the above combination, when consumed in combination with a coffee drink, also can reduce the negative and unwanted side effects of coffee, while enhancing the desired feeling of focus and alertness. Side effects including having jitters, feeling over stimulated, anxiousness, and having an increase in both heart rate and blood pressure when faced with tasks that the average adult would encounter in their daily life with work or school. An enhancement of the focus and alertness desired from coffee, with a smoothing of this sensation, reducing the ‘high’ and ‘crash’ many people can experience when the effects of coffee wear off. Addition of B Vitamin(s) and Vitamin D, when consumed in combination with a coffee drink, can also boost immunity, add an enhanced sense of energy, and reduce the loss of key vitamins due to a diuretic effect of coffee. These ingredients provide support for a feeling of energy without adding an unwanted added stimulating effect beyond what coffee alone provides.

Species of Camellia sinensis or an Extract Derived from the Species of Camellia sinensis

Camellia sinensis is a genus for different species of plants that have leaves suitable for making tea (also known as tea leaves). Species of Camellia sinensis that are used in the disclosed additive include black tea plant, green tea plant, or a combination of black tea plant and green tea plant. The species of Camellia sinensis can be embodied as black tea leaf/leaves, green tea leaf/leaves, or a combination of black tea leaf/leaves and green tea leaf/leaves.

In embodiments that utilize an extract derived from a species of Camellia sinensis, the extract can be derived from, isolated from, or otherwise obtained from, a green tea leaf/leaves.

In embodiments, the extract can contain from about 1 wt % to about 99 wt % polyphenols based on a total weight of the extract of the green tea leaf/leaves in the additive; alternatively, from about 15 wt % to about 98 wt % polyphenols based on a total weight of the extract of the green tea leaf/leaves in the additive; alternatively, from about 95 wt % to about 98 wt % polyphenols based on a total weight of the extract of the green tea leaf/leaves in the additive; alternatively, about 15, 19, 50, 60, 70, 95, or 98 wt % polyphenols based on a total weight of the extract of the green tea leaf/leaves in the additive.

In embodiments, the extract can contain from about 1 wt % to about 99 wt % catechins based on a total weight of the extract of the green tea leaf/leaves in the additive; alternatively, from about 15 wt % to about 98 wt % catechins based on a total weight of the extract of the green tea leaf/leaves in the additive; alternatively, from about 50 wt % to about 98 wt % catechins based on a total weight of the extract of the green tea leaf/leaves in the additive; alternatively, about 15, 19, 50, 60, 70, 95, or 98 wt % catechins based on a total weight of the extract of the green tea leaf/leaves in the additive.

In additional or alternative embodiments, the extract can contain from about 1 wt % to about 99 wt % epigallocatechin-3-gallate (EGCG) based on a total weight of the extract of the green tea leaf/leaves in the additive; alternatively, from about 2.5 wt % to about 65 wt % EGCG based on a total weight of the extract of the green tea leaf/leaves in the additive; alternatively, from about 40 wt % to about 65 wt % EGCG based on a total weight of the extract of the green tea leaf/leaves in the additive; alternatively, about 2.5, 4, 13, 20, 25, 40, 50, or 65 wt % EGCG based on a total weight of the extract of the green tea leaf/leaves in the additive.

In embodiments, the species of Camellia sinensis or the extract derived from the species of Camellia sinensis can be present in the additive in an amount of from about 1 mg to about 5,000 mg; alternatively, from about 50 mg to 1200 mg; alternatively, from about 200 mg to about 600 mg; alternatively, 100, 200, 300, 400, 500, 600, 700, 800, or 900 mg.

### An Extract of a Green Coffee Bean

The green coffee bean from which the extract of the green coffee bean is derived, isolated, or otherwise obtained, can be selected from an arabica coffee bean, a canephora coffee bean, a eugenioides coffee bean, a robusta coffee bean, a reacemosa coffee bean, a liberica coffee bean, or a combination thereof.

In embodiments, the extract of the green coffee bean can include from about 1 wt % to about 99 wt % chlorogenic acid or any salt or derivative thereof based on a total weight of the extract of the green coffee bean; alternatively, from about 10 wt % to about 65 wt % chlorogenic acid or any salt or derivative thereof based on a total weight of the extract of the green coffee bean; alternatively, from about 40 wt % to about 50 wt % chlorogenic acid or any salt or derivative thereof based on a total weight of the extract of the green coffee bean; alternatively, about 10, 20, 30, 40, or 50 wt % chlorogenic acid or any salt or derivative thereof based on a total weight of the extract of the green coffee bean.

In some aspects, the extract of the green coffee bean can be pure chlorogenic acid or any salt or derivative thereof. That is, the extract of the green coffee bean can be pure chlorogenic acid, any pure salt of chlorogenic acid, any pure derivative of chlorogenic acid, or a combination thereof. In this context, “pure” can indicate that the extract is greater than 99.0, 99.1, 99.2, 99.3, 99.4, 99.5, 99.6, 99.7, 99.8, or 99.9 wt % of chlorogenic acid, any salt, or any derivative thereof based on a total weight of the extract of the green coffee bean.

In embodiments, the extract of the green coffee bean can be present in the additive in an amount of from about 1 mg to about 5,000 mg; alternatively, from about 100 mg to 2000 mg; alternatively, from about 100 mg to about 300 mg; alternatively, 100, 200, 300, 400, 500, 600, 700, 800, or 900 mg.

### L-Theanine or any Salt or Derivative Thereof

L-theanine or any salt or derivative thereof can be embodied as L-theanine, any salt of L-theanine, any derivative of L-theanine, or a combination of two or more of L-theanine, any salt of L-theanine, and any derivative of L-theanine.

In embodiments, L-theanine or any salt or derivative thereof can be present in the additive in an amount of from about 1 mg to about 5,000 mg; alternatively, from about 50 mg to 300 mg; alternatively, from about 100 mg to about 200 mg; alternatively, 50, 100, 150, 200, 250, or 300 mg.

Without being limited to theory, it is believed that L-theanine can reduce anxiety, reduce jitters, reduce the increase in heart rate, reduce the increase in blood pressure, or combinations thereof that are associated with ingestion of coffee.

Salts of L-theanine include any salt of L-theanine that is prepared by the addition of an acid to L-theanine. Non-limiting examples of suitable salts of L-theanine can include L-theanine tartrate, L-theanine chloride, L-theanine bromide, L-theanine acid aspartate, L-theanine acid phosphate, L-theanine fumarate, L-theanine lactate, L-theanine maleate, L-theanine acid maleate, L-theanine acid oxalate, L-theanine acid sulfate, L-theanine glucose phosphate, L-theanine acid tartrate, L-theanine iodate, L-theanine aspartate, L-theanine citrate, L-theanine acid citrate, L-theanine acid fumarate, L-theanine glycerophosphate, L-theanine mucate, L-theanine orotate, L-theanine oxalate, L-theanine sulfate, L-theanine trichloroacetate, L-theanine trifluoroacetate, L-theanine methanesulfonate, L-theanine pamoate, L-theanine acid pamoate, or a combination thereof.

Derivatives of L-theanine can include the esters and amides of L-theanine.

### Additional Ingredients

In addition to the trio of ingredients discussed hereinabove, the disclosed additive can additionally include one or more of L-carnitine or any salt or derivative thereof, vitamin B12, vitamin B6, vitamin D, and chromium picolinate.

### L-Carnitine

L-carnitine or any salt or derivative thereof can be embodied as L-carnitine, any salt of L-carnitine, any derivative of L-carnitine, or a combination of two or more of L-carnitine, any salt of L-carnitine, and any derivative of L-carnitine.

In embodiments, L-carnitine or any salt or derivative thereof can be present in the additive in an amount of from about 1 mg to about 5,000 mg; alternatively, from about 100 mg to 900 mg; alternatively, from about 100 mg to about 500 mg; alternatively, 100, 200, 300, 400, 500, 600, 700, 800, or 900 mg.

Without being limited to theory, it is believed that L-carnitine can facilitate the metabolism of lipids, or fat burning. L-carnitine is primarily synthesized in the liver and the kidneys and has a physiological role in transporting long-chain fatty acids across the mitochondrial membrane and into the mitochondrion for metabolism and removal of unwanted compounds.

Salts of L-carnitine include any salt of L-carnitine that is prepared by the addition of an acid to L-carnitine. Non-limiting examples of suitable salts of L-carnitine can include L-carnitine tartrate, L-carnitine chloride, L-carnitine bromide, L-carnitine acid aspartate, L-carnitine acid phosphate, L-carnitine fumarate, L-carnitine lactate, L-carnitine maleate, L-carnitine acid maleate, L-carnitine acid oxalate, L-carnitine acid sulfate, L-carnitine glucose phosphate, L-carnitine acid tartrate, L-carnitine iodate, L-carnitine aspartate, L-carnitine citrate, L-carnitine acid citrate, L-carnitine acid fumarate, L-carnitine glycerophosphate, L-carnitine mucate, L-carnitine orotate, L-carnitine oxalate, L-carnitine sulfate, L-carnitine trichloroacetate, L-carnitine trifluoroacetate, L-carnitine methanesulfonate, L-carnitine pamoate, L-carnitine acid pamoate, or a combination thereof.

Derivatives of L-carnitine can include any of C₂ to C₈ alkanoyl L-carnitine. Salts of C₂ to C₈ alkanoyl L-carnitine can include C₂ to C₈ alkanoyl L-carnitine chloride, C₂ to C₈ alkanoyl L-carnitine bromide, C₂ to C₈ alkanoyl L-carnitine orotate, C₂ to C₈ alkanoyl L-carnitine acid aspartate, C₂ to C₈ alkanoyl L-carnitine acid phosphate, C₂ to C₈ alkanoyl L-carnitine fumarate, C₂ to C₈ alkanoyl L-carnitine lactate, C₂ to C₈ alkanoyl L-carnitine maleate, C₂ to C₈ alkanoyl L-carnitine acid maleate, C₂ to C₈ alkanoyl L-carnitine acid oxalate, C₂ to C₈ alkanoyl L-carnitine acid sulfate, C₂ to C₈ alkanoyl L-carnitine glucose phosphate, C₂ to C₈ alkanoyl L-carnitine tartrate, C₂ to C₈ alkanoyl L-carnitine acid tartrate, C₂ to C₈ alkanoyl L-carnitine iodate, C₂ to C₈ alkanoyl L-carnitine aspartate, C₂ to C₈ alkanoyl L-carnitine citrate, C₂ to C₈ alkanoyl L-carnitine acid citrate, C₂ to C₈ alkanoyl L-carnitine acid fumarate, C₂ to C₈ alkanoyl L-carnitine glycerophosphate, C₂ to C₈ alkanoyl L-carnitine mucate, C₂ to C₈ alkanoyl L-carnitine orotate, C₂ to C₈ alkanoyl L-carnitine oxalate, C₂ to C₈ alkanoyl L-carnitine sulfate, C₂ to C₈ alkanoyl L-carnitine trichloroacetate, C₂ to C₈ alkanoyl L-carnitine trifluoroacetate, C₂ to C₈ alkanoyl L-carnitine methanesulfonate, C₂ to C₈ alkanoyl L-carnitine pamoate, C₂ to C₈ alkanoyl L-carnitine acid pamoate, or a combination thereof.

### Vitamin B₁₂

The additive can include vitamin B₁₂. “Vitamin B₁₂” as used in the additive refers to any form of vitamin B₁₂, include an ingestible form of cyanocobalamin that can be converted to a more biologically available form after ingestion.

In embodiments, vitamin B₁₂ can be present in the additive in an amount of from about 0.001 mg to about 1 mg; alternatively, from about 0.001 mg to 0.5 mg; alternatively, from about 0.0025 mg to about 0.1 mg; alternatively, 0.003, 0.005, 0.0075, or 0.01 mg.

### Vitamin B₆

The additive can include vitamin B₆, which can comprise any of the compounds known to fall within the scope of vitamin B₆. “Vitamin B₆” as used in the additive can refer to any form of vitamin B₆, including an ingestible form of pyridoxine that can be converted to a more metabolically active form after ingestion.

In embodiments, vitamin B₆ can be present in the additive in an amount of from about 0.1 mg to about 10 mg; alternatively, from about 0.5 mg to 5 mg; alternatively, from about 0.75 mg to about 2.5 mg; alternatively, 0.5, 0.75, 1.0, 1.5, or 2.5 mg.

### Vitamin D

The additive can include vitamin D, which can comprise any of the species of vitamin D known to fall within the scope of vitamin D. “Vitamin D” as used in the additive can refer to any form of vitamin D, including an ingestible form that can be converted to a more metabolically active and/or biologically active form after ingestion.

In embodiments, vitamin D can be present in the additive in an amount of from about 0.001 mg to about 1 mg; alternatively, from about 0.005 mg to 0.5 mg; alternatively, from about 0.01 mg to about 0.05 mg; alternatively, 0.005, 0.01, 0.02, 0.025, or 0.03 mg.

### Chromium Picolinate

The additive can include chromium picolinate.

In embodiments, chromium picolinate or any salt or derivative thereof can be present in the additive in an amount of from about 0.001 mg to about 1 mg; alternatively, from about 0.005 mg to 0.05 mg; alternatively, from about 0.01 mg to about 0.05 mg; alternatively, 0.005, 0.01, 0.02, 0.025, or 0.03 mg.

Chromium picolinate can be formed by mixing elemental chromium with picolinic acid. Chromium picolinate can function to increase insulin efficiency within the body, clean the blood, and to direct the body to a fat burning state. The chromium ion available from chromium picolinate can improve glucose tolerance, improve serum lipid concentrations (including high-density lipoprotein cholesterol), and improve insulin efficiency within the body. That is, chromium ions can enhance insulin function, which is to transport glucose to the various cells of the body so as to provide the energy for cells, and can help the body metabolize carbohydrates and fats. Chromium ions available from chromium picolinate can also clean the blood by removing excess sugar and reducing cholesterol from blood. The picolinate ion available from chromium picolinate can function as a metabolite for amino acids that are produced by the body, such as for tryptophan produced in the liver, kidney, and pancreas. The picolinate ion can also bind to or otherwise complex with zinc, copper, and chromium ions in the body for transport of these metals from the small intestine to the blood.

### Carrier

In embodiments, the additive can include one or more carriers selected from maltodextrin, MCT oil, gelatin, pectin, glycerin, glucose syrup, sugar, sodium citrate, or a combination thereof.

In embodiments, the additive can include from about 500 mg to 10,000 mg carrier based on a total weight of the additive; alternatively, from about 500 mg to 5,000 mg carrier based on a total weight of the additive; alternatively, from about 500 mg to 3,000 mg carrier based on a total weight of the additive; alternatively, about 500, 750, 1000, 1500, 2000, 2500, 3000, 4000, or 5000 mg.

In embodiments, the weight ratio of carrier to actives in the additive can range from about 0.8:1 to about 25:1; alternatively, from about 0.8:1 to about 12.5:1; alternatively, from about 0.8:1 to about 7.5:1; alternatively, from about 0.8:1 to about 5:1; alternatively, from about 0.8:1 to about 2.5:1. “Actives” in this ratio can refer to the nutritional additives described above that contribute to the beneficial effects described herein, including 1) a species of Camellia sinensis or an extract derived from the species of Camellia sinensis, 2) an extract of a green coffee bean, and 3) L-theanine or any salt or derivative thereof, and 4) optionally one or more of L-carnitine or any salt or derivative thereof, Vitamin B₁₂, Vitamin B₆, Vitamin D, and chromium picolinate. For example, the carrier can be included in the additive in an amount of from about 500 mg to 10,000 mg, and the actives can be included in an amount of from about 400 mg to about 600 mg; alternatively, the carrier can be included in the additive in an amount of from about 500 mg to 5,000 mg, and the actives can be included in an amount of from about 400 mg to about 600 mg; alternatively, the carrier can be included in the additive in an amount of from about 500 mg to 3,000 mg, and the actives can be included in an amount of from about 400 mg to about 600 mg; alternatively, the carrier can be included in the additive in an amount of from about 500 mg to 2,000 mg, and the actives can be included in an amount of from about 400 mg to about 600 mg; alternatively, the carrier can be included in the additive in an amount of from about 500 mg to 1,000 mg, and the actives can be included in an amount of from about 400 mg to about 600 mg.

### Sweetener

In embodiments, the additive can include one or more sweeteners selected from fructooligosaccharide, sucrose, aspartame, stevia, acesulfame potassium, maltodextrin, sucralose, or a combination thereof.

### Natural Flavors

In embodiments, the additive can include one or more natural flavors selected from almond extract, hazelnut extract, vanilla extract, or a combination thereof.

### Bitter Masking Agent

In embodiments, the additive can include one or more bitter masking agents selected from a sodium compound (e.g., sodium chloride, sodium benzoate), a potassium compound (e.g., potassium sorbate), aspartame, sucralose, citric acid, or a combination thereof.

### Method for Preparing the Coffee Additive

Disclosed herein is a method for preparing the additive disclosed herein. The method can include mixing a first set of ingredients comprising a species of Camellia sinensis or an extract derived from the species of Camellia sinensis, an extract of a green coffee bean, and L-theanine or any salt or derivative thereof, in any of the amounts disclosed herein, to form a first mixture. The method can additionally include mixing one or more of L-carnitine or any salt or derivative thereof, vitamin B₁₂, vitamin B₆, vitamin D, chromium picolinate, and a carrier with the first mixture, in any of the amounts disclosed herein to form a second mixture. The method can additionally include forming the first mixture or the second mixture into a dry powder, a liquid tincture, a gelatin, or a gel.

In embodiments, the additive in the form of a dry powder can be contained within a packet (e.g., a flat-rectangular shaped pouch such as those used for sweeteners), or manufactured to be contained with a capsule, a caplet, or a tablet. In embodiments, the additive in the form of a liquid tincture can be contained in a bottle, a caplet, a capsule, a liquid gel, or a gummy. In embodiments, the additive in the form of a gelatin can be contained in a gummy. In embodiments, the additive in the form of a gel can be contained in a liquid gel.

### Coffee Drink and Method for Preparing the Coffee Drink

Also disclosed herein is a coffee drink that contains the disclosed additive. In embodiments, the coffee drink can be a hot coffee drink, a cold coffee drink, a cappuccino, a latte, an espresso, a cold brew, a nitro brew made by a drip coffee method, an instant coffee method, or any other method, that contains the additive having ingredients in the amounts disclosed herein.

A method for preparing a coffee drink can include mixing a coffee-containing liquid or coffee-derived drink (e.g., coffee, cappuccino, latte, expresso) with an embodiment of the additive disclosed herein. Mixing can be accomplished by preparing the coffee-containing liquid or coffee-derived drink by any method known in the art with the aid of this disclosure, preparing the additive according to the disclosure, and adding the additive to the coffee-containing liquid or coffee-derived drink to form a consumable beverage having the advantages disclosed herein. Alternatively, mixing can be accomplished by preparing the coffee-containing liquid or coffee-derived drink by any method known in the art with the aid of this disclosure, preparing the additive according to the disclosure, and adding the coffee-containing liquid or coffee-derived drink to the additive to form a consumable beverage having the advantages disclosed herein. Alternatively, mixing can be accomplished by preparing the coffee-containing liquid or coffee-derived drink by any method known in the art with the aid of this disclosure, preparing the additive according to the disclosure, and adding the additive and a coffee-containing liquid or coffee-derived drink to a container to form a consumable beverage having the advantage disclosed herein.

When mixing the additive and coffee-containing liquid or coffee-derived drink to form a consumable beverage, the amount of the additive can be in the range of from about 500 mg to about 10 g and the amount of the coffee-containing liquid or coffee-derived drink to form a consumable beverage can be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, or 32 ounces.

Embodiments that result from combining or omitting features of the embodiment(s) are considered to be within the scope of the disclosure. Numerical ranges should be understood to include the endpoint values unless expressly disclosed to the contrary (e.g., from about X to about Y includes X and Y; between X and Y includes X and Y; greater than or less than X does not include value X). Moreover, each numerical range should be understood to include each numerical value falling between the endpoints (e.g., from 0.1 to 1 includes, 0.1 0.2, 0.3, 0.4, 0.5, 0.6, 0.7, 0.8, 0.9, and 1); greater than 1 includes 1, 2, 3, and so on). It is contemplated that express disclosure of terms such as comprises, contains, includes, having, and their grammatical variants provides support for narrower terms, including but not limited to consisting of and consisting essentially of.

What is claimed is:

1. A coffee additive comprising:
a species of Camellia sinensis or an extract derived from the species of Camellia sinensis;
an extract of a green coffee bean; and
L-theanine or any salt or derivative thereof.

2. The coffee additive of claim 1, wherein the species of Camellia sinensis or the extract derived from the species of Camellia sinensis is present in an amount of from about 1 mg to about 5,000 mg, wherein the extract of the green coffee bean is present in an amount of from about 1 mg to about 5,000 mg, and wherein the L-theanine or any salt or derivative thereof is present in an amount of from about 1 mg to about 5,000 mg.

3. The coffee additive of claim 1, wherein the species of Camellia sinensis or an extract derived from the species of Camellia sinensis comprises a green tea leaf, a black tea leaf, or a combination of green tea leaf and black tea leaf.

4. The coffee additive of claim 1, wherein species of Camellia sinensis or an extract derived from the species of Camellia sinensis is the extract derived from the species of Camellia sinensis, wherein the extract derived from the species of Camellia sinensis comprises an extract of a green tea leaf, wherein the extract of the green tea leaf comprises from about 1 wt % to about 99 wt % polyphenols based on a total weight of the extract of the green tea leaf in the coffee additive.

5. The coffee additive of claim 1, wherein the green coffee bean is selected from an arabica coffee bean, a canephora coffee bean, a eugenioides coffee bean, a robusta coffee bean, a reacemosa coffee bean, a liberica coffee bean, or a combination thereof.

6. The coffee additive of claim 1, wherein the extract of the green coffee bean comprises from about 1 wt % to about 99 wt % chlorogenic acid or any salt or derivative thereof based on a total weight of the extract of the green coffee bean.

7. The coffee additive of claim 1, wherein the extract of the green coffee bean is pure chlorogenic acid or any salt or derivative thereof.

8. The coffee additive of claim 1, further comprising L-carnitine or any salt or derivative thereof in an amount of from about 1 mg to about 5,000 mg.

9. The coffee additive of claim 8, further comprising vitamin B₁₂ in an amount of from about 0.001 mg to about 1 mg.

10. The coffee additive of claim 9, further comprising vitamin B₆ in an amount of from about 0.1 mg to about 10 mg.

11. The coffee additive of claim 10, further comprising vitamin D in an amount of from about 0.001 mg to about 1 mg.

12. The coffee additive of claim 11, further comprising chromium picolinate or any salt or derivative thereof, in an amount of from about 0.001 mg to about 1 mg.

13. The coffee additive of claim 1, further comprising carrier selected from maltodextrin, MCT oil, gelatin, pectin, glycerin, glucose syrup, sugar, sodium citrate, or a combination thereof.

14. The coffee additive of claim 13, in the form of a dry powder, a liquid tincture, a capsule, a caplet, a tablet, a gummy, or a liquid gel.

15. The coffee additive of claim 1, further comprising fructooligosaccharide, sucrose, aspartame, stevia, acesulfame potassium, maltodextrin, sucralose, or a combination thereof.

16. The coffee additive of claim 1, further comprising almond extract, hazelnut extract, vanilla extract, or a combination thereof.

17. The coffee additive of claim 1, further comprising a bitter masking agent comprising a sodium compound (sodium chloride, sodium benzoate), a potassium compound (potassium sorbate), aspartame, sucralose, citric acid, or a combination thereof.

18. A coffee drink comprising coffee and the coffee additive of claim 1, wherein the coffee drink is a hot coffee drink, a cold coffee drink, a cappuccino, a latte, an espresso, a cold brew, a nitro brew made by a drip coffee method, an instant coffee method, or any other method.

19. A method for preparing a coffee drink comprising:
mixing coffee with the coffee additive of claim 1.

20. A method for preparing a coffee additive, comprising:
mixing a species of Camellia sinensis or an extract derived from the species of Camellia sinensis, an extract of a green coffee bean, and L-theanine or any salt or derivative thereof.
